(19) United States
(12) Patent Application Publication
(10) Pub. No.: US 2024/0042518 A1
(43) Pub. Date: Feb. 8, 2024

(54) SYSTEMS AND METHODS OF CONTROLLING GAS FLOW IN A MOLD IN ALUMINUM CASTING

(71) Applicant: Novelis Inc., Atlanta, GA (US)

(72) Inventors: John Robert Buster McCallum, Spokane, WA (US); John S. Tingey, Rathdrum, ID (US)

(73) Assignee: Novelis Inc., Atlanta, GA (US)

(21) Appl. No.: 18/258,670

(22) PCT Filed: Dec. 13, 2021
(86) PCT No.: PCT/US2021/063012

§ 371 Date: Jun. 21, 2023

Related U.S. Application Data
(60) Provisional application No. 63/199,373, filed on Dec. 22, 2020.

(51) Int. Cl. B22D 27/00

(52) U.S. Cl. CPC B22D 27/003; B22D 27/006

(57) ABSTRACT

Disclosed herein are gas control systems and associated methods of controlling gas in a mold in casting, such as aluminum casting. The system may have a first mass controller, a second mass controller, and a control device capable of switching the gas control system between a first operating state and a second operating state. The first mass controller and the second mass controller may have different flow rate ranges. In the first operating state, the gas control system may deactivate one of the first or second mass controllers, and in the second operating state, the gas control system may activate both first and second mass controllers.

### REFERENCE TO RELATED APPLICATION

This application claims the benefit of U.S. Provisional Patent Application No. 63/199,373, filed on Dec. 22, 2020 and entitled SYSTEMS AND METHODS OF CONTROLLING GAS FLOW IN A MOLD IN ALUMINUM CASTING, the content of which is hereby incorporated by reference in its entirety.

### FIELD

The present disclosure relates to metallurgy generally and more specifically to a control system for casting metals in a mold.

### BACKGROUND

Aluminum casting in molds can make use of gas controllers to ensure that the shell of the forming billet does not adhere to the mold walls. AIRSLIP® is an example of such a system. AIRSLIP® may ensure a cast aluminum item is in a “slip” state, where the forming billet is separated from the mold by air pockets and the shell steadily forms at a relatively uniform thickness. The gas flow used must ensure a stable gaseous pocket between the mold and solidifying metal. The gas mixture used must promote a thin but continuous oxide on the metal surface.

The gas controllers can be set for particular casting speeds or changes in surface quality, which may require different concentrations or flow rates of each gas flowing through the mold. Certain casts may require changing of the concentrations of gas mid-cast or between casts. Such changes may cause the forming billet to fall out of said slip state and alter the air pockets that keep the forming billet separated from the mold or cause regions of the billet to have an undesirable thickness. These regions are lost material that must be scrapped.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Described are systems and methods of maintaining a cast metal product in a slip state while altering volumetric flow of mass in a mold during a casting process. During billet casting, as the metal casts in the mold, a two-gas system may be used at different flow rates to assist in formation of the billet and preventing adherence to the mold, maintaining the billet in a slip state. However, outside of the slip state, the casting billet may form regions of wasted scrap. In order to reduce material loss, a control system may be used that maintains the slip state even across changing volumetric flow rates.

In some embodiments, a gas control system for controlling gas flow in a casting process is described. The gas control system may include a first mass controller, configured to supply at least one gas into a casting mold at a first flow rate, a second mass controller configured to supply the at least one gas into the casting mold at a second flow rate, and a control device configured to control the first mass controller and the second mass controller, such that the gas control system is in at least one of a first operating state or a second operating state. In the first operating state, at least one of the first mass controller or the second mass controller is deactivated to not supply the at least one gas into the casting mold, and the other of the first mass controller or the second mass controller is activated to supply gas into the casting mold. In the second operating state, both the first mass controller and the second mass controller are activated, such that both the first mass controller and the second mass controller supply the at least one gas into the casting mold, with the deactivated mass controller now in an activated state.

In some embodiments, a method of controlling gas flow is described. The method may include activating a first mass controller to supply at least one gas into a casting mold at a first flow rate, setting the gas control system into a first operating state. The gas control system can be switched to a second operating state by activating a second mass controller to supply the at least one gas into the casting mold at a second flow rate, setting the gas control system into a second operating state. The gas control system can then be switched back to the first operating state by deactivating the first mass controller.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1 is a control system for maintaining a cast metal product in a slip state, according to embodiments.

FIG. 2 is a view of the mold of the control system, according to embodiments.

FIG. 3 is a flowchart illustrating a method of maintaining a cast metal product in a slip state, according to embodiments.

FIG. 4 is a simplified block diagram showing an example computer system for use with the system of FIG. 1, according to embodiments.

### DETAILED DESCRIPTION

The following examples will serve to further illustrate the present disclosure without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the disclosure.

Described herein is a gas control system for maintaining a casting metal product in a slip state and associated methods. As used herein, “slip state” refers to a state in which air pockets separate the casting metal product from the mold walls such that the casting metal product does not contact the mold. The slip state can be achieved, and maintained, by the flow of one or more gases into the mold through proportional-integral-derivative (PID) mass controllers. For example, in a one-gas system, a single gas, such as 100% oxygen, can be flowed in to maintain the slip state. For example, in a two-gas system, two gases, such as an aluminum reactive gas and an aluminum non-reactive gas, can be pumped into the mold to expedite the formation of a shell around the casting metal product, while simultaneously forming air pockets to separate the shell from the mold. A casting system may employ the gas control system, for example, in a continuous casting system, or otherwise. In an embodiment, the continuous casting system may be used for casting billets in a horizontal configuration.

Conditions, such as changing the surface quality of the cast metal product, adjusting cast speed, may require that parameters of the case be changed, such as adjusting cast speed, the flow of cooling water, the metal temperature, and mold gas flows/mixtures. For this, an operator may input a desired gas parameter. Based on the desired parameter, a desired flow rate is determined for at least one of the gases supplied into the casting mold. Due to the nature of PID controllers in iterative adjustments, the gas flowing through a mass controller may have a shut off period, an undershoot period, and an overshoot period before properly adjusting to the new desired flowrate of the gas. During the periods of adjustment, the casting metal product will fall out of the slip state and scrap metal is generated until the slip state is reobtained.

The disclosed gas control system allows for maintaining the slip state despite changing conditions as the mass controller(s) adjust to meet the desired flow rate. The gas control system includes a set of mass controllers. The gas control system may control the flow of a gas in a one-gas system, and when the system is a two-gas system (or other gas system), the gas control system may control the flow rate of each of a first gas, a second gas, etc.

The set of mass controllers includes a first mass controller that is configured to supply a particular gas (e.g., a first gas) at a flow rate within first range of flow rates and a second mass controller that is configured to supply the particular gas at a flow rate within a second range of flow rates that is different from the first range of flow rates. In various examples, the set of mass controllers may include additional mass controllers that are configured to supply the particular gas at flow rates that are within other ranges of flow rates. For examples, in one non-limiting embodiment, the set of mass controllers includes a third mass controller that is configured to supply the particular gas at a flow rate within a third range of flow rates that is different from the first range of flow rates and different from the second range of flow rates. As such, the number of mass controllers and/or the ranges of flow rates provided by particular mass controllers should not be considered limiting. For example, in embodiments, a system may have two sets of mass controller, with each set of mass controller in fluid communication with only one gas. Each mass controller of the set of mass controllers is in fluid communication with a gas supply such that the particular gas can be supplied to each of the mass controllers. In a two-gas system with a first gas and a second gas, each mass controller may be in fluid communication with a first gas supply and/or a second gas supply.

During a casting process, in a first operating state, a particular gas is supplied into the casting mold by a single mass controller. As an example, the gas may be supplied into the casting mold by the first mass controller at a flow rate that is within the first range of flow rates. In a two-gas system, each gas is supplied by a single mass controller. As an example, the first gas may be supplied into the casting mold by the first mass controller and the second gas may be supplied into the casting mold by the second mass controller at a flow rate that is within a second range of flow rates that is different from the first range of flow rates. During the casting process, the gas control system may be in the first operating state for a longest duration.

In some cases, it may be desirable to change the flow rate of a particular gas being supplied into the casting mold and/or to change the mass controller that supplies the particular gas to the casting mold. As a non-limiting example, it may be desirable to change the supply of the particular gas from the first mass controller to the second mass controller (e.g., to have a flow rate that is outside of the range of flow rates provided by the first mass controller, to have a different range of flow rates available, etc.). As a non-limiting example of the two-gas system, it may be desirable to change the supply of the first gas from the first mass controller to the second mass controller and to change the supply of the second gas from the second mass controller to the third mass controller.

To change the mass controller that is supplying the particular gas into the casting mold, a control device of the gas control system controls the mass controllers to be in a second operating state. In the second operating state, at least two mass controllers supply the particular gas into the casting mold at the same time. In various aspects, in the second operating state, both the original mass controller and a newly activated mass controller are activated at the same time. As a non-limiting example, in the second operating state, the first gas may be supplied into the casting mold by both the first mass controller and the second mass controller. In certain aspects, the gas control system is in the second operating state for a predetermined period of time. In some cases, the gas control system is in the second operating state until the particular gas is being supplied by the newly activated mass controller for the particular gas at a desired flow rate. As a non-limiting example, the gas control system may be in the second operating state until the first gas is being supplied by the second mass controller at a desired flow rate. In various examples, the control device controls the mass controllers in the second operating state such that the flow of the gas from the originally activated mass controller is progressively decreased while the flow of the gas from the newly activated mass controller is progressively increased. As a non-limiting example, the control device controls the mass controllers in the second operating state such that the flow of the first gas from the first mass controller is progressively decreased while the flow of the first gas from the second mass controller is progressively increased.

In various aspects, after the predetermined time period of being in the second operating state and/or after a particular event (e.g., a desired flow rate) occurs, the control device controls the mass controllers such that the gas control system returns to the first operating state. In certain cases, the gas control system returns to the first operating state by deactivating the originally activated mass controller such that the particular gas is only supplied into the casting mold by the newly activated mass controller. As a non-limiting example, the control device controls the mass controllers to return to the first operating state by deactivating the first mass controller such that only the second mass controller supplies the first gas into the casting mold. In embodiments where a set of mass controllers is in fluid communication with one gas, a second set of mass controllers can be used to bring the gas control system into the second operating state, and the deactivating one of the sets of mass controllers can return the gas control system to the first operating state.

In various examples, the second operating state may maintain the cast metal product in the slip state. For example, the maintained flow of a particular gas (e.g., the first gas) through the original mass controller (e.g. the first mass controller) allows the newly activated mass controller (e.g., the second mass controller) to adjust to the desired flow rate without losing the slip state. Once the desired flow rate is achieved, the flow of the particular gas through the original mass controller is discontinued and the newly activated mass controller takes over as the only activated mass controller for the particular gas. Thus, even as the newly activated mass controller goes through its iterative adjustment, there is no scrap metal produced because the original mass controller continues to supply the particular gas.

While certain aspects of the present disclosure may be suitable for use with any type of material, such as metal, certain aspects of the present disclosure may be especially suitable for use with aluminum or aluminum alloys.

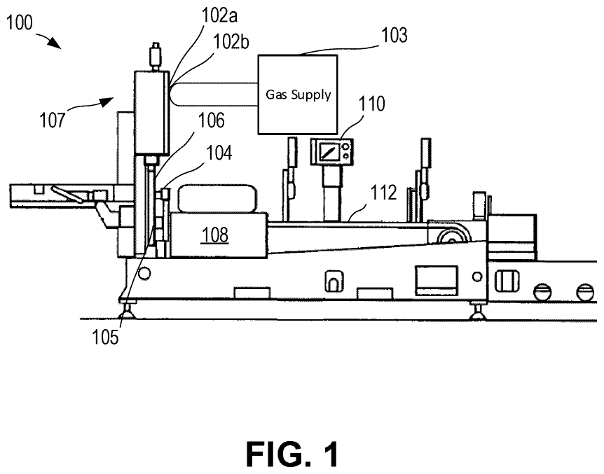

FIG. 1 is a metal casting system 100 with a control system 107 according to embodiments. The metal casting system 100 may be a horizontal continuous casting system with two or more mass controllers 102, a casting mold 104, a sensor 105, gas conduits 106, a conveyer system 108 with a conveyer 112, and a control device 110.

The casting mold 104 may receive molten metal through one or more mold openings. The molten metal may be contained and formed by the casting mold 104. While FIG. 1 depicts the casting mold 104 as a horizontal continuous casting system for billets or other cast metal products, various other types of casting molds may utilize the control system 107, such as a direct chill cast system for ingots, or any other suitable casting system. After exiting the mold, the cast metal product may move through the conveyer system 108, along the conveyer 112. The conveyer system 108 may carry the cast metal product towards downstream processing, such as a rolling mill or other metal processing systems. The conveyer system 108 may use clamps or other means of holding the cast metal product in place throughout the casting process.

The control system 107 may control molten metal flowing through the casting mold 104 to maintain the slip state. The control system 107 may regulate the mass controllers 102 that pump gas from a gas supply 103 to the casting mold 104 through the gas conduits 106. In some embodiments, the control system 107 may operate the mass controllers 102 to utilize a two-gas system in maintaining the cast metal product in a slip state while it is casting. A cast metal product in said slip state may be separated from the mold walls of the casting mold 104 by air pockets as the outer shell of the cast metal product forms.

The two-gas system may utilize at least a first gas, which may be a reactive gas, and a second gas, which may be a non-reactive gas, from a gas supply 103. In some cases, the first gas may be oxygen and the second gas may be argon, although other combinations of non-reactive and reactive gases may be employed. In embodiments, a pairing of two reactive gases, or two nonreactive gases may be used. In single-gas system embodiments, a single gas can be used. The gas supply 103 may receive the two gases from separate sources. Moreover, while a single gas supply 103 is illustrated, in a two-gas system (or other multi-gas system), each gas may have a dedicated gas supply. The gas supply 103 may pump each gas to the control system 107 through a manifold. In some embodiments, the gas flows through a T-valve, although any means of regulating the gases into the control system 107 may be used.

To maintain a slip state in the casting metal product, air pockets formed between the mold wall of the casting mold 104 and the cast metal product are regulated using the mass controllers 102 within the control system 107. The mass controllers 102 control the flow of each of the first gas and the second gas into the mold, and the flow of the gases controls the air pockets formed between the mold 104 and the metal product. In various examples, the control system 107 includes at least two mass controllers 102, each having a range of flow rates that is different from the other. In one non-limiting example, the metal casting system 100 may include a first mass controller 102a that can supply a flow rate within a first range of flow rates, a second mass controller 102b that can supply a flow rate within a second range of flow rates different from the first range, and a third mass controller 102c that can supply a flow rate within a third range of flow rates that is different from the first range and different from the second range. In a two-gas system, during casting, the first gas may be supplied by any one of the mass controllers (e.g., the first mass controller 102a) while the second gas is supplied by another one of the mass controllers (e.g., the second mass controller 102b). In a first operating state of the gas control system, the first gas is supplied by a single one of the mass controllers (e.g., the first mass controller 102a) while the second gas is supplied by another single one of the mass controllers (e.g., the second mass controller 102b). In a second operating state of the gas control system, at least one of the gases (e.g., the first gas) is supplied by at least two mass controllers (e.g., the first mass controller 102a and the third mass controller 102c).

In embodiments, the mass controllers 102 may be capable of switching between the different gas sources of the gas supply 103 to provide a desired flow rate of a particular gas. As a non-limiting example, the first mass controller 102a can switch from supplying the first gas to supplying the second gas, and the second mass controller 102b can switch from supplying the second gas to supplying the first gas if desired. The control system 107 may have any number of mass controllers 102, such as two, three, four or more than four mass controllers to regulate different flow rates of the gases from the gas supply 103.

In some embodiments, the range of flow rates from each mass controllers 102 may be various ranges as desired. As one non-limiting example, ranges of flow rates provided by a particular mass controller may be 0-20 sccm, 0-200 sccm, 0-1000 sccm, 0-2000 sccm or otherwise. Different mass controllers within the control system 107 may each have a different range of possible flow rates. As one non-limiting example, the first range of the first mass controller 102a may be 0-20 sccm, the second range of the second mass controller 102b may be 0-200 sccm, and the third range of the third mass controller 102c may be 0-1000 sccm.

During a casting operation when the system is in the first operating state, two mass controllers 102 may be used or activated at the same time while at least one mass controller 102 is not used (when the gas control system includes three or more mass controllers). For example, mass controller 102a may be activated to supply the first gas into the casting mold and mass controller 102b may be activated to supply the second gas into the casting mold. When the cast undergoes a change and/or when a new flow rate for one or both of the gases is desired, the supply of a particular gas (e.g., the first gas) may be switched from the currently activated mass controller (e.g., the first mass controller 102a) to a new mass controller (e.g., the third mass controller 102c). As discussed in detail below, the gas control system may enter a second operating state to switch the supply of the particular gas from one mass controller to another, during which the particular gas is supplied by two mass controllers into the casting mold to maintain the cast metal product in a slip state while the system achieves the desired flow.

The sensor 105 may be positioned upstream of the casting mold 104. While FIG. 1 shows one sensor, the system may include two, three, or more sensors as needed. The sensor 105 may measure concentration of one or more gases flowing into the casting mold 104, the pressure of the gases flowing into the casting mold 104, and/or any other parameter that may be fed into the control system 107 and may be used to control the supply of one or more gases into the casting mold 104.

The control device 110 may be used to control the mass controllers to control the flow of the first gas (and the second gas) into the casting mold. In some cases, the control device may have a user interface and may receive operator input to set different desired or target parameters of the cast, such as the ratio between the two gases, the flow rate of each gas, or any user-controlled variable. In other examples, the control device may control the mass controllers 102 based on a detected deviation of actual parameters from desired or target parameters. In examples where the desired parameter is not a flow rate, the system may determine a flow rate of a particular gas from the mass controllers to achieve the desired parameter. For example, an operator may wish to change the parameters dictating particular ratios between the two gases for different surface finishes in a cast metal product, or alter the ratio for differently sized cast metal products between a cast. In such examples, the system may determine the desired flow rate of one or both gases such that the gases are at the desired ratio. In traditional systems, as the parameters change between casts or even mid-cast, the mass controllers 102 may have a margin of error as the mass controllers 102 alter the flow rate such that the particular gas has or achieves the target parameter. Within this margin of error, a forming cast metal product may have surface deformations or exit the slip state, resulting in wasted material that must be scrapped. The metal casting system disclosed herein utilizes a second operating state during which a particular gas is supplied by two mass controllers to the casting mold to account for this margin of error and maintain the slip state despite the changing parameters.

In embodiments, a processor of control device 110 may utilize the sensor 105 to detect an error with the casting process in the casting system 100. The processor, or a form of generic controller, may adjust the mass controllers 102 to restore the casting process. In embodiments, the processor may automate the adjustment of the mass controllers 102 based off of data from the sensor 105.

As the parameters for a cast change to a new gas parameter, for example, as the flow rate and/or concentration of one of the gases changes, the control system 107 may ensure no error region where the cast metal product exits the slip state occurs as the supply of a particular gas is switched from one mass controller (e.g., the first mass controller 102a) to another mass controller (e.g., the third mass controller 102c) such that the new desired flow rate is achieved. In various aspects, the control system 107 minimizes or eliminates the error region during such a change by operating the mass controllers in a second operating state. In the second operating state, for a particular gas (e.g., the first gas or the second gas), as the one of the mass controllers (e.g., the first mass controller 102a) adjusts the flowrate of the particular gas flowing through it towards the desired flow rate (i.e., the flow rate that provides the new gas parameter), the new mass controller (e.g., the third mass controller 102c) is turned on so that the particular gas is provided through two mass controllers. Once the desired flow rate is reached, the original mass controller (e.g., the first mass controller 102a) may be deactivated and shut off and the control system 107 returns to the first operating state with the gas being supplied by a single controller, which is now the newly activated mass controller (e.g., the third mass controller 102c).

By controlling the mass controllers to be in the second operating state during a change from one mass controller to another mass controller, the control system 107 may reduce wasted materials by preventing a shutoff period for a particular gas (i.e., a period when a particular gas is not supplied by any mass controller) as the system adjusts to the new flow rate. In effect, by utilizing the second operating state, the flow of the changing gas may be maintained during cast even as parameters of that gas flow change to a new flow rate during the cast, ensuring the cast metal product is in a slip state while the supplemental mass controller adjusts. The control system 107 may control the mass controllers such that, for each gas, the mass controllers can be in the second operating state at the same time or at different times. In other words, the control system 107 can change the mass controller supplying the second gas while also changing the mass controller supplying the first gas or before and/or after changing the mass controller supplying the first gas.

In some embodiments, the control system may be implemented in such a metal casting system as described in U.S. Pat. No. 7,077,186, which is incorporated herein by reference.

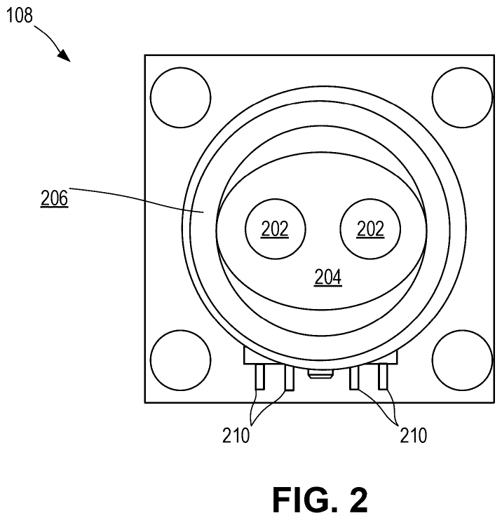

FIG. 2 is a front view of a casting mold 104, according to embodiments. The casting mold 104 may have mold openings 202, a mold cover plate 204, and a baseplate 206. The casting mold 104 may have inlets 210 for receiving gas from each mass controller 102 within the control system 107. The casting mold 104 may be secured by various bolts, fasteners, screws or other securing components as suitable. While FIG. 2 depicts four inlets, there may be more or fewer as needed depending on the number of mass controllers 102. Further, while casting mold 104 is shown in a twin-billet configuration, the casting mold 104 may be any mold capable of handling molten metal into a cast metal product.

The mold openings 202 may be configured to extrude a cast metal product as the cast metal product forms. While the casting mold 104 shown is a twin-billet configuration, other casting molds, such as molds for casting an ingot, sheet, or other metal product may be used. The mold openings 202 may intake the gases from a gas supply such as gas supply 103 through the inlets 210 to maintain the extruded cast metal product in a slip state. In some embodiments, the mold openings 202 may be incorporated with the mold cover plate 204.

The inlets 210 may be connectively coupled with gas conduits, such as the gas conduits 106, to deliver gas from the gas supply 103. The inlets 210 may direct gas into the casting mold 104. The inlets 210 may further extend to route the flowing gas into the mold openings 202 to achieve slip state in a casting metal product. The inlets 210 may maintain a concentration of a gas flowing within the gas conduits 106 as it is directed into the mold openings 202. The inlets 210 may direct the gases into the casting mold 104 such that a more metallically reactive gas (e.g., the first gas) penetrates further into the mold openings 202, and a less metallically reactive gas (e.g., the second gas) remains proximally closer to the walls of the mold openings 202. This may be achieved by directing the inlets 210 at different distances into the casting mold 104, by varying the flow rates between the two gases, directing the inlets 210 at varying angles relative to the mold walls of the casting mold 104, or otherwise. In embodiments, the less metallically reactive gas may remain proximally closer to the walls of the mold openings 202 and the less metallically reactive gas may penetrate further into the mold openings 202.

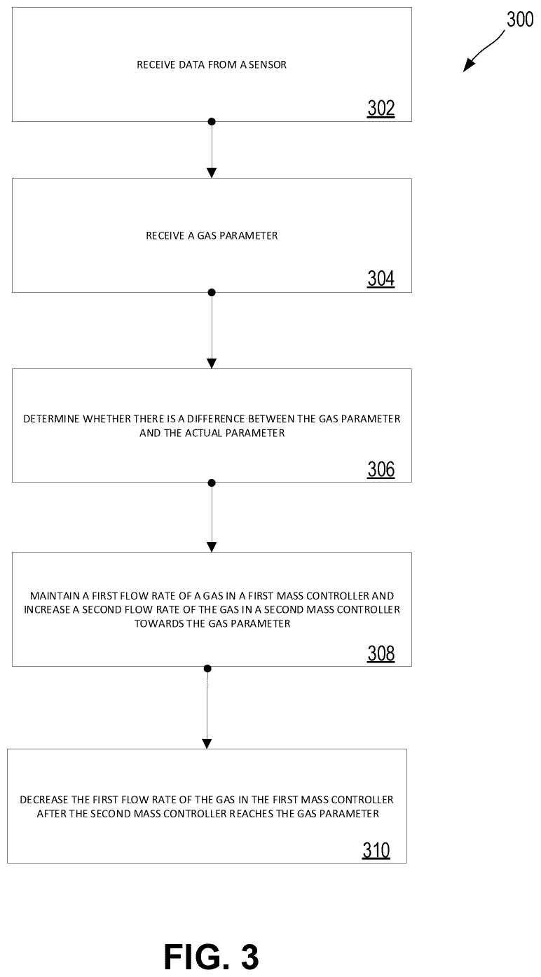

FIG. 3 is a flowchart diagram of a method of maintaining a cast metal product in a slip state, such as using the control system 107. The method will be described in the context of controlling the supply of the first gas (e.g., oxygen) into the casting mold, but the following method may also or alternatively be used to control the supply of the second gas into the casting mold.

In operation 302, data from a sensor, such as sensor 105, is received by a processor. The data may include one or more measured gas parameters within a mold, such as casting mold 104. In embodiments, the measured gas parameter may be the flow rate of the first gas, the concentration profiles of the first gas flowing into the casting mold, the concentration profile of the first gas within the mold, the pressure levels of the first gas within the mold, or otherwise. As a non-limiting example and for purposes of illustrating the method, a sensor operating mid-cast may detect as a measured gas parameter that the first gas (e.g., oxygen) is flowing at 150 sccm. As previously mentioned, the sensor may also measure one or more gas parameters relating to the second gas. As a non-limiting example, the sensor may also detect that the second gas (e.g., argon) is flowing at 15 sccm. In various aspects, the sensor 105 measures the gas parameters at least while the gas control system is in the first operating state (i.e., the first gas is supplied by a single mass controller). The gas parameters may be received by the control device as the data.

In operation 304, a desired gas parameter is received by the processor of the control device 110. The gas parameter may be set by an operator, based off a feedback loop, inherited as a default value from an earlier cast, or otherwise. The gas parameter may be one or more desired gas parameters of the first gas, such as desired concentration profiles of the first gas, desired flow rates for the first gas flowing into the mold, or otherwise. For example, an operator that wishes for a particular surface quality on the metal product midway through a cast may use the control device to provide a gas parameter having a desired oxygen flow rate to obtain the particular surface quality.

In operation 306, the control device may determine whether there is a difference between the desired gas parameter and the actual gas parameter as measured by the sensor. In various examples, if the actual gas parameter is already at (or within a predetermined range) of the desired gas parameter, the operation 306 may return to operation 302 and/or wait for a new desired gas parameter.

If there is a difference between the desired gas parameter and the actual gas parameter, the control device may determine a flow rate of the first gas that can provide the desired gas parameter (if the gas parameter is not already provided as a desired flow rate). As one non-limiting example, if the desired gas parameter is a desired concentration of the first gas within the casting mold, the control device may determine a desired flow rate that can provide the desired concentration.

Operation 306 may include determining whether the desired flow rate can be provided by the mass controller currently supplying the first gas to the casting mold. If the mass controller currently supplying the first gas to the casting mold (e.g., the first mass controller 102a) can provide the desired flow rate, the control device may control the current mass controller to supply the gas at the desired flow rate.

If the currently activated mass controller (also referred to as the “old” mass controller) supplying the first gas cannot provide the desired flow rate, the control device may determine another mass controller (e.g., the second mass controller 102b) (also referred to as the “new” mass controller) to supply the first gas at the desired flow rate. Based on the determination of the new mass controller to supply the first gas at the desired flow rate, in operation 306, the control device activates the new mass controller such that the gas control system is in the second operating state, and the first gas is supplied by both the old mass controller and the new mass controller. In various examples, in the second operating state, the new mass controller may begin supplying the first gas at a second flow rate, where the second flow rate is based in part on the desired flow rate (corresponding to the desired gas parameter). As one example, the second flow rate of the gas in the new mass controller may start at 0 sccm and increase to the desired flow rate of the gas based on the desired gas parameter. In some embodiments, increasing the second flow rate of the gas in the new mass controller may cause the flow rate to go through an overshoot and undershoot region of adjustment, for example, when a PID controller is used as the mass controller(s).

In operation 308, the processor maintains the first flow rate of the gas in the old mass controller, as the second flow rate increases in the new mass controller. The maintaining of the first flow rate may be based on the gas parameter being different from the measured gas parameter as defined in operation 304. Furthermore, operation 306 and operation 308 may occur simultaneously.

In operation 310, once the second flow rate of the new mass controller has stabilized at the desired flow rate that corresponds to the gas parameter, the processor may decrease the first flow rate of the gas in the old mass controller. The flow rate of the old mass controller eventually drops to zero, and the new mass controller takes over the role of the only mass controller that supplies the first gas into the mold. The decrease in flow rate may, in part, be determined by the determination as described in operation 306. Once the old mass controller is deactivated (i.e., the flow rate is zero), the gas control system returns to a first operating state where a single mass controller (i.e., the new mass controller) is providing the first gas into the casting mold.

An example implementation of the above method may be for a forming aluminum billet in a continuous casting system. As described in operation 302, sensor data regarding the gas flow rate and concentration of oxygen is received by a processor. The processor may then receive a gas parameter for oxygen, as in operation 304, such as a lower oxygen concentration (e.g., a lower desired concentration of the first gas than is being currently supplied). The gas parameter may also include different parameters or combinations of parameters, such as ratio of the two gases, concentration of one or both of the gases, flow rate of one or both of the gases, or otherwise. The processor may then maintain a flow rate of oxygen flowing via the first mass controller 102a as the third mass controller 102c begins adjustment of the flow rate corresponding to the desired gas parameter, going through the undershoot and overshoot regions typical in a PID controller, as in operation 306 and operation 308. Once oxygen supplied by the third mass controller 102c reaches the desired flow rate to achieve the desired gas parameter, the first mass controller 102a shuts off the first flow of oxygen, as in operation 310. By supplying oxygen through both the first mass controller 102a and the third mass controller 102c in the second operating state during periods of adjustment, the parameters of the gas may change to achieve a desired cast while maintaining the cast metal product in the slip state.

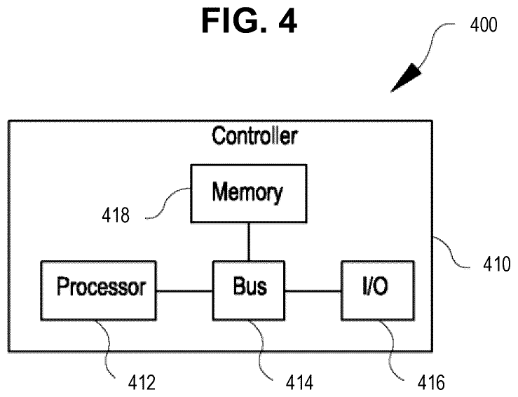

FIG. 4 is a simplified block diagram showing an example computer system 400 for use with the system 100 for maintaining a cast metal product in a slip state, such as the system of FIG. 1. The control device 110, for example, may include the computer system 400. The computer is communicatively coupled with the sensor, mass controllers, and other components of the system 100. In some embodiments, the computer system 400 performs one, some, or all of the steps of process 300. However, the computer system 400 may perform additional and/or alternative steps. In various embodiments, the computer system 400 includes a controller 410 that is implemented digitally and is programmable using conventional computer components. The controller 410 may be used in connection with certain examples (e.g., including equipment such as shown in FIG. 1) to carry out the processes of such examples. The controller 410 includes a processor 412 that can execute code stored on a tangible computer-readable medium in a memory 418 (or elsewhere such as portable media, on a server or in the cloud among other media) to cause the controller 410 to receive and process data and to perform actions and/or control components of equipment such as shown in FIG. 1. The controller 410 may be any device that can process data and execute code that is a set of instructions to perform actions such as to control industrial equipment. As non-limiting examples, the controller 410 can take the form of a digitally implemented and/or programmable PID controller, a programmable logic controller, a microprocessor, a server, a desktop or laptop personal computer, a laptop personal computer, a handheld computing device, and a mobile device.

Examples of the processor 412 include any desired processing circuitry, an application-specific integrated circuit (ASIC), programmable logic, a state machine, or other suitable circuitry. The processor 412 may include one processor or any number of processors. The processor 412 can access code stored in the memory 418 via a bus 414. The memory 418 may be any non-transitory computer-readable medium configured for tangibly embodying code and can include electronic, magnetic, or optical devices. Examples of the memory 418 include random access memory (RAM), read-only memory (ROM), flash memory, a floppy disk, compact disc, digital video device, magnetic disk, an ASIC, a configured processor, or other storage device.

Instructions can be stored in the memory 418 or in the processor 412 as executable code. The instructions can include processor-specific instructions generated by a compiler and/or an interpreter from code written in any suitable computer-programming language. The instructions can take the form of an application that includes directing and altering the flow of gas through the mass controllers when executed by the processor 412, allow the controller 410 to maintain a slip state within a cast metal product by controlling elements of the system of FIG. 1.

The controller 410 shown in FIG. 4 includes an input/output (I/O) interface 414 through which the controller 410 can communicate with devices and systems external to the controller 410, including components such as the gas supply 103, the casting mold 104, the first mass controller 102a, the second mass controller 102b, the third mass controller 102c, any related sensors, and/or other components as desired. The input/output (I/O) interface 414 can also, if desired, receive input data from other external sources. Such sources can include control panels, other human/machine interfaces, computers, servers or other equipment that can, for example, send instructions and parameters to the controller 410 to control its performance and operation; store and facilitate programming of applications that allow the controller 410 to execute instructions in those applications to maintain a cast metal product within a slip state, such as in connection with the processes of certain examples of this disclosure; and other sources of data necessary or useful for the controller 410 in carrying out its functions. Such data can be communicated to the input/output (I/O) interface 414 via a network, hardwire, wirelessly, via bus, or as otherwise desired.

Although specific embodiments of the disclosure have been described, various modifications, alterations, alternative constructions, and equivalents are also encompassed within the scope of the disclosure. Embodiments of the present disclosure are not restricted to operation within certain specific environments, but are free to operate within a plurality of environments. Additionally, although method embodiments of the present disclosure have been described using a particular series of operations and steps, it should be apparent to those skilled in the art that the scope of the present disclosure is not limited to the described series of operations and steps.

The specification and drawings are, accordingly, to be regarded in an illustrative rather than a restrictive sense. It will, however, be evident that additions, subtractions, deletions, and other modifications and changes may be made thereunto without departing from the broader spirit and scope.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 5.1, and ending with a maximum value of 10 or less, e.g., 5.5 to 10.

The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. As used herein, the meaning of “a,” “an,” and “the” includes singular and plural references unless the context clearly dictates otherwise.

### Illustrations

As used below, any reference to a series of illustrations is to be understood as a reference to each of those examples disjunctively (e.g., “Illustrations 1-4” is to be understood as “Illustrations 1, 2, 3, or 4”).

Illustration 1 is a gas control system for controlling gas flow in a casting process, the gas control system comprising: a first mass controller configured to supply at least one gas into a casting mold at a first flow rate that is within a first flow rate range; a second mass controller configured to supply the at least one gas into the casting mold at a second flow rate, wherein the second flow rate is within a second flow rate range that is different from the first flow rate range; and a control device configured to control the first mass controller and the second mass controller such that the gas control system is in at least one of a first operating state or a second operating state, wherein, in the first operating state, at least one of the first mass controller or the second mass controller is deactivated and the other one of the first mass controller or the second mass controller is activated such that the deactivated first mass controller or the deactivated second mass controller does not supply the at least one gas into the casting mold, and wherein, in the second operating state, both the first mass controller and the second mass controller are activated such that both the first mass controller and the second mass controller supply the at least one gas into the casting mold, wherein, in the second operating state, the at least one of the first mass controller or the second mass controller that was activated in the first operating state is an originally activated mass controller, and the other one of the first mass controller or the second mass controller that was deactivated in the first operating state is an originally deactivated mass controller.

Illustration 2 is a gas control system of any of the preceding or subsequent illustrations wherein the control device is configured to control the first mass controller and the second mass controller such that a duration in which the gas control system is in the first operating state during the casting process is longer than a duration in which the gas control system is in the second operating state.

Illustration 3 is a gas control system of any of the preceding or subsequent illustrations wherein the control device is configured to change the first mass controller or the second mass controller which is the activated mass controller and which is the deactivated mass controller in the first operating state by: receiving a desired flow rate of the at least one gas, wherein the desired flow rate is based on a desired parameter of the at least one gas; determining, while the gas control system is in the first operating state, if the desired flow rate of the at least one gas can be supplied by the originally activated mass controller; based on the desired flow rate not being able to be supplied by the originally activated mass controller, activating the originally deactivated mass controller such that the gas control system is in the second operating state; and after a predetermined time, deactivating the originally activated mass controller such that the gas control system is in the first operating state with the originally deactivated mass controller now activated and supplying the at least one gas into the casting mold.

Illustration 4 is a gas control system of any of the preceding or subsequent illustrations wherein the control device is configured to activate the originally deactivated mass controller such that the gas control system is in the second operating state by increasing the flow rate of the at least one gas from the originally deactivated mass controller toward the desired flow rate while decreasing the flow rate of the at least one gas from the originally activated mass controller.

Illustration 5 is a gas control system of any of the preceding or subsequent illustrations wherein, once the flow rate from the originally deactivated mass controller is at the desired flow rate, the control device deactivates the originally activated mass controller such that the gas control system returns to the first operating state and only the originally deactivated mass controller supplies the at least one gas.

Illustration 6 is a gas control system of any of the preceding or subsequent illustrations further comprising the casting mold.

Illustration 7 is a gas control system of any of the preceding or subsequent illustrations further comprising a gas supply in fluid communication with the first mass controller and the second mass controller.

Illustration 8 is a gas control system of any of the preceding or subsequent illustrations further comprising: a third mass controller configured to supply the at least one gas into a casting mold at a third flow rate that is within a third flow rate range, wherein the third flow rate range is different from the first flow rate range and different from the second flow rate range.

Illustration 9 is a gas control system of any of the preceding or subsequent illustrations wherein the first flow rate range is 0-20 sccm, wherein the second flow rate range is 0-200 sccm, and wherein the third flow rate range is 0-1000 sccm.

Illustration 10 is a gas control system of any of the preceding or subsequent illustrations wherein the first mass controller, the second mass controller, and the third mass controller are a set of mass controllers, and wherein: in the first operating state, one mass controller of the set of mass controllers is activated and two mass controllers of the set of mass controllers are deactivated such that the deactivated mass controllers do not supply the at least one gas into the casting mold, and in the second operating state, two mass controllers of the set of mass controllers are activated and one mass controller of the set of mass controllers is deactivated such that the two activated mass controllers supply the at least one gas into the casting mold.

Illustration 11 is a gas control system of any of the preceding or subsequent illustrations wherein the at least one gas comprises oxygen or argon.

Illustration 12 is a gas control system of any of the preceding or subsequent illustrations wherein the first mass controller and the second mass controller each comprise proportional-integrative-derivative controllers.

Illustration 13 is a method of controlling gas flow, comprising activating a first mass controller to supply a gas into a casting mold at a first flow rate that is within a first flow rate range, thereby setting a gas control system into a first operating state; switching the gas control system to a second operating state by activating a second mass controller to supply the gas into the casting mold at a second flow rate that is within a second flow rate range, wherein both the first mass controller and the second mass controller supply the gas into the casting mold during the second operating state; and switching the gas control system back to the first operating state by deactivating the first mass controller.

Illustration 14 is the method of controlling gas flow of any of the preceding or subsequent illustrations further comprising receiving a gas parameter.

Illustration 15 is the method of controlling gas flow of any of the preceding or subsequent illustrations, wherein receiving the gas parameter comprises receiving at least one of a flow rate, a concentration, or a pressure level.

Illustration 16 is the method of controlling gas flow of any of the preceding or subsequent illustrations, wherein activating the first mass controller and activating the second mass controller comprise activating proportional-integral-derivative controllers.

Illustration 17 is the method of controlling gas flow of any of the preceding or subsequent illustrations wherein outputting the gas comprises outputting oxygen gas or argon gas.

Illustration 18 is the method of controlling gas flow of any of the preceding or subsequent illustrations further comprising maintaining a third flow rate of a second gas in a third mass controller during the first operating state and the second operating state.

Illustration 19 is a gas control system for a casting device, the gas control system comprising: a first mass controller configured to supply a gas into a casting mold at a first flow rate that is within a first flow rate range; a second mass controller configured to supply the gas into the casting mold at a second flow rate, wherein the second flow rate is within a second flow rate range that is different from the first flow rate range; and a control device configured to control the first mass controller and the second mass controller such the gas is continuously supplied into the casting mold during a casting process.

Illustration 20 is the gas control system of any of the preceding or subsequent illustrations wherein the control device is configured to control the first mass controller and the second mass controller such that the gas control system is in at least one of a first operating state or a second operating state, wherein: in the first operating state, at least one of the first mass controller or the second mass controller is deactivated and the other one of the first mass controller or the second mass controller is activated such that the deactivated first mass controller or the deactivated second mass controller does not supply the gas into the casting mold; and in the second operating state, both the first mass controller and the second mass controller are activated such that both the first mass controller and the second mass controller supply the gas into the casting mold.

Illustration 21 is the gas control system of any of the preceding or subsequent illustrations wherein the gas comprises oxygen or argon.

Illustration 22 is a method of controlling gas flow comprising: controlling a first gas controller to supply a gas into a casting mold at a first flow rate that is within a first flow rate range; activating a second gas controller to begin supplying the gas into the casting mold at a second flow rate, wherein the second flow rate is within a second flow rate range that is different from the first flow rate range and the first gas controller and the second gas controller are both supplying the gas into the casting mold; and deactivating the first gas controller.

Illustration 23 is a gas control system for a casting device, the gas control system comprising: a plurality of mass controllers, each mass controller of the plurality of mass controllers configured to supply a gas into a casting mold at a flow rate, wherein a flow rate range of at least one mass controller of the plurality of mass controllers is different from a flow rate range of another mass controller of the plurality of mass controllers; and a control device communicatively coupled to the plurality of mass controllers and configured to control the plurality of mass controllers such that at least one mass controller of the plurality of mass controllers is always active and supplying the gas into the casting mold during a casting process.

Illustration 24 is the gas control system of any of the preceding or subsequent illustrations wherein the control device is configured to control a first mass controller of the plurality of mass controllers and a second mass controller of the plurality of mass controllers such that the gas control system is in at least one of a first operating state or a second operating state, wherein: in the first operating state, at least one of the first mass controller or the second mass controller is deactivated and the other one of the first mass controller or the second mass controller is activated such that the deactivated first mass controller or the deactivated second mass controller does not supply the gas into the casting mold; and in the second operating state, both the first mass controller and the second mass controller are activated such that both the first mass controller and the second mass controller supply the gas into the casting mold.

Illustration 25 is the gas control system of any of the preceding or subsequent illustrations wherein the gas comprises oxygen or argon.

Illustration 26 is a method of controlling gas flow comprising: activating a gas controller of a plurality of gas controllers and thereby supplying a gas into a casting mold, the gas controller having a different flow rate range than each of the other gas controllers of the plurality of gas controllers; and, in an event of the gas controller shutting off, activating a different gas controller of the plurality of gas controllers, thereby maintaining and supplying the gas into the casting mold during a casting process.

Illustration 27 is a gas control system for controlling the flow of a first gas and a second gas in a casting process the gas control system comprising: a first mass controller configured to supply gas into a casting mold at a first flow rate that is within a first flow rate range; a second mass controller configured to supply gas into the casting mold at a second flow rate, wherein the second flow rate is within a second flow rate range that is different from the first flow rate range; and a control device configured to control the first mass controller and the second mass controller such that, for each of the first gas and the second gas, the gas control system is in at least one of a first operating state or a second operating state, wherein, for a selected gas comprising the first gas or the second gas:in the first operating state, at least one of the first mass controller or the second mass controller is deactivated and the other one of the first mass controller or the second mass controller is activated such that the deactivated first mass controller or the deactivated second mass controller does not supply the selected gas into the casting mold, and in the second operating state, both the first mass controller and the second mass controller are activated such that both the first mass controller and the second mass controller supply the selected gas into the casting mold.

Illustration 28 is the method of controlling gas flow of any of the preceding or subsequent illustrations, wherein the selected gas is the first gas and wherein the first gas comprises oxygen.

Illustration 29 is the method of controlling gas flow of any of the preceding or subsequent illustrations wherein the selected gas is the second gas, and wherein the second gas comprises argon.

Illustration 30 is the method of controlling gas comprising: receiving data from a sensor; receiving a gas parameter; determining a difference between the received gas parameter and an actual gas parameter; maintaining a first flow rate in a first mass controller and simultaneously increasing a second flow rate in a second mass controller; and decreasing the first flow rate in the first mass controller once the second flow rate in the second mass controller ceases increasing.

Illustration 31 is a method of controlling gas of any preceding or subsequent illustrations further comprising: further decreasing the first flow rate in the first mass controller; and further increasing the second flow rate in the second mass controller.

What is claimed is:

1. A gas control system for a casting device, the gas control system comprising:
a first mass controller configured to supply a gas into a casting mold at a first flow rate that is within a first flow rate range;
a second mass controller configured to supply the gas into the casting mold at a second flow rate, wherein the second flow rate is within a second flow rate range that is different from the first flow rate range; and
a control device configured to control the first mass controller and the second mass controller such the gas is continuously supplied into the casting mold during a casting process.

2. The gas control system of claim 1, wherein the gas comprises oxygen or argon.

3. The gas control system of claim 1, wherein the control device is configured to control the first mass controller and the second mass controller such that the gas control system is in at least one of a first operating state or a second operating state, wherein:
in the first operating state, at least one of the first mass controller or the second mass controller is deactivated and the other one of the first mass controller or the second mass controller is activated such that the deactivated first mass controller or the deactivated second mass controller does not supply the gas into the casting mold; and
in the second operating state, both the first mass controller and the second mass controller are activated such that both the first mass controller and the second mass controller supply the gas into the casting mold.

4. The gas control system of claim 3, wherein the control device is configured to control the first mass controller and the second mass controller such that a duration in which the gas control system is in the first operating state during the casting process is longer than a duration in which the gas control system is in the second operating state.

5. The gas control system of claim 3, wherein the control device is configured to change the first mass controller or the second mass controller which is the activated mass controller and which is the deactivated mass controller in the first operating state by:
receiving a desired flow rate of the gas, wherein the desired flow rate is based on a desired parameter of the gas;
determining, while the gas control system is in the first operating state, if the desired flow rate of the gas can be supplied by the originally activated mass controller;
based on the desired flow rate not being able to be supplied by the originally activated mass controller, activating the originally deactivated mass controller such that the gas control system is in the second operating state; and
after a predetermined time, deactivating the originally activated mass controller such that the gas control system is in the first operating state with the originally deactivated mass controller now activated and supplying the gas into the casting mold.

6. The gas control system of claim 1, further comprising:
a third mass controller configured to supply the gas into a casting mold at a third flow rate that is within a third flow rate range, wherein the third flow rate range is different from the first flow rate range and different from the second flow rate range.

7. The gas control system of claim 6, wherein the first flow rate range is 0-20 sccm, wherein the second flow rate range is 0-200 sccm, and wherein the third flow rate range is 0-1000 sccm.

8. A gas control system for a casting device, the gas control system comprising:
a plurality of mass controllers, each mass controller of the plurality of mass controllers configured to supply a gas into a casting mold at a flow rate, wherein a flow rate range of at least one mass controller of the plurality of mass controllers is different from a flow rate range of another mass controller of the plurality of mass controllers; and
a control device communicatively coupled to the plurality of mass controllers and configured to control the plurality of mass controllers such that at least one mass controller of the plurality of mass controllers is always active and supplying the gas into the casting mold during a casting process.

9. The gas control system of claim 8, wherein the control device is configured to control a first mass controller of the plurality of mass controllers and a second mass controller of the plurality of mass controllers such that the gas control system is in at least one of a first operating state or a second operating state, wherein:
in the first operating state, at least one of the first mass controller or the second mass controller is deactivated and the other one of the first mass controller or the second mass controller is activated such that the deactivated first mass controller or the deactivated second mass controller does not supply the gas into the casting mold; and
in the second operating state, both the first mass controller and the second mass controller are activated such that both the first mass controller and the second mass controller supply the gas into the casting mold.

10. The gas control system of claim 9, wherein the control device is configured to control the first mass controller and the second mass controller of the plurality of mass controllers such that a duration in which the gas control system is in the first operating state during the casting process is longer than a duration in which the gas control system is in the second operating state.

11. The gas control system of claim 8, wherein the gas comprises oxygen or argon.

12. The gas control system of claim 8, further comprising at least one of the casting mold or at least one gas supply in fluid communication with the plurality of mass controllers.

13. The gas control system of claim 8, wherein the plurality of mass controllers further comprises a third mass controller configured to supply the gas into a casting mold at a third flow rate that is within a third flow rate range of 0-1000 sccm.

14. A gas control system for controlling a flow of a first gas and a second gas in a casting process, the gas control system comprising:
a first mass controller configured to supply gas into a casting mold at a first flow rate that is within a first flow rate range;
a second mass controller configured to supply gas into the casting mold at a second flow rate, wherein the second flow rate is within a second flow rate range that is different from the first flow rate range; and
a control device configured to control the first mass controller and the second mass controller such that, for each of the first gas and the second gas, the gas control system is in at least one of a first operating state or a second operating state,
wherein, for a selected gas comprising the first gas or the second gas:
in the first operating state, at least one of the first mass controller or the second mass controller is deactivated and the other one of the first mass controller or the second mass controller is activated such that the deactivated first mass controller or the deactivated second mass controller does not supply the selected gas into the casting mold, and
in the second operating state, both the first mass controller and the second mass controller are activated such that both the first mass controller and the second mass controller supply the selected gas into the casting mold.

15. The gas control system of claim 14, wherein the selected gas is the first gas, and wherein the first gas comprises oxygen.

16. The gas control system of claim 14, wherein the selected gas is the second gas, and wherein the second gas comprises argon.

17. The gas control system of claim 14, wherein the control device is configured to control the first mass controller and the second mass controller such that a duration in which the gas control system is in the first operating state during the casting process is longer than a duration in which the gas control system is in the second operating state.

18. The gas control system of claim 14, wherein the control device is configured to change the first mass controller or the second mass controller which is the activated mass controller and which is the deactivated mass controller in the first operating state by:
receiving a desired flow rate of the gas, wherein the desired flow rate is based on a desired parameter of the gas;
determining, while the gas control system is in the first operating state, if the desired flow rate of the gas can be supplied by the originally activated mass controller;
based on the desired flow rate not being able to be supplied by the originally activated mass controller, activating the originally deactivated mass controller such that the gas control system is in the second operating state; and
after a predetermined time, deactivating the originally activated mass controller such that the gas control system is in the first operating state with the originally deactivated mass controller now activated and supplying the gas into the casting mold.

19. The gas control system of claim 18, wherein the control device is configured to activate the originally deactivated mass controller such that the gas control system is in the second operating state by increasing the flow rate of the gas from the originally deactivated mass controller toward the desired flow rate while decreasing the flow rate of the gas from the originally activated mass controller.

20. The gas control system of claim 1, further comprising:
a third mass controller configured to supply the gas into a casting mold at a third flow rate that is within a third flow rate range, wherein the third flow rate range is different from the first flow rate range and different from the second flow rate range,
wherein the first mass controller, the second mass controller, and the third mass controller are a set of mass controllers, and wherein:
in the first operating state, one mass controller of the set of mass controllers is activated and two mass controllers of the set of mass controllers are deactivated such that the deactivated mass controllers do not supply the gas into the casting mold, and
in the second operating state, two mass controllers of the set of mass controllers are activated and one mass controller of the set of mass controllers is deactivated such that the two activated mass controllers supply the gas into the casting mold.
